(19) United States
(12) Patent Application Publication
(10) Pub. No.: US 2025/0141646 A1
(43) Pub. Date: May 1, 2025

(54) INFORMATION PROCESSING METHOD AND APPARATUS, COMMUNICATION DEVICE, AND STORAGE MEDIUM

(71) Applicant: Beijing Xiaomi Mobile Software Co., Ltd., Beijing (CN)

(72) Inventors: Yanhua LI, Beijing (CN); Yumin WU, Beijing (CN)

(73) Assignee: Beijing Xiaomi Mobile Software Co., Ltd., Beijing (CN)

(21) Appl. No.: 18/837,339

(22) PCT Filed: Feb. 12, 2022
(86) PCT No.: PCT/CN2022/076118

§ 371 Date: Aug. 9, 2024

(51) Int. Cl. H04L 5/00

(52) U.S. Cl. CPC H04L 5/0094; H04L 5/0048

(57) ABSTRACT

Provided in the embodiments of the present disclosure are an information processing method and apparatus, a communication device, and a storage medium. The information processing method is executed by a base station, and includes sending configuration information of a reference signal, wherein the configuration information includes combination configuration information indicating a combination configuration, and the combination configuration includes a set of at least one IE for indicating a resource set of the reference signal.

### CROSS-REFERENCE TO RELATED APPLICATIONS

The present application is a national phase application of International Application No. PCT/CN2022/076118, filed on Feb. 12, 2022, and the entire contents of which are incorporated herein by reference.

### TECHNICAL FIELD

The present disclosure relates to, but is not limited to, the field of communication technology, and in particular to an information processing method, an apparatus, a communication device, and a storage medium.

### BACKGROUND

In the current 3GPP standardization of the R17 power saving project, it is proposed to use additional Tracking Reference Signal (TRS) or Channel State Information-Reference Signal (CSI-RS) in the idle state to assist users in acquiring time and frequency domain synchronization with the network. Compared with the original Synchronization Signal Block (SSB) synchronization, TRS or CSI-RS configuration can be configured closer to the Paging Occasion (PO) timing; and the original SSB is far away from the PO position, so the User Equipment (UE) needs to wake up a long time in advance to synchronize with the SSB. After using the additional TRS or CSI-RS, the UE can wake up later, so it can save more power.

In the system information, the configuration information of the additional TRS or CSI-RS to be broadcast, and the available status information of whether the TRS or CSI-RS is being broadcast, can be considered to be indicated separately; that is, the network is likely to have configured the TRS or CSI-RS, but no actual transmission is performed, that is, it is not used by the UE in the radio control resource (RRC) idle or inactive stat.

Currently, the configuration information of TRS or CSI-RS is usually placed in the system information block (SIB).

It should be noted that, information disclosed in the above background portion is provided only for better understanding of the background of the present disclosure, and thus it may contain information that does not form the prior art known by those ordinary skilled in the art.

### SUMMARY

The embodiments of the present disclosure provide an information processing method, apparatus, communication device and storage medium.

According to a first aspect of the present disclosure, there is provided an information processing method, which is executed by a base station and includes:
sending configuration information of a reference signal, wherein the configuration information includes: combined configuration information indicating a combined configuration; wherein the combined configuration includes: a set of at least one information element (IE) for indicating a resource set of a reference signal.

According to a second aspect of the present disclosure, there is provided an information processing method, which is performed by a UE and includes:
receiving configuration information of a reference signal, wherein the configuration information includes: combined configuration information indicating a combined configuration; wherein the combined configuration includes: a set of at least one IE for indicating a resource set of a reference signal.

According to a third aspect of the present disclosure, there is provided an information processing apparatus, applied to a base station, including:
a sending module, configured to send configuration information of a reference signal, wherein the configuration information includes: combined configuration information indicating a combined configuration; wherein the combined configuration includes: a set of at least one information element (IE) for indicating a resource set of a reference signal.

According to a fourth aspect of the present disclosure, there is provided an information processing apparatus, applied to a UE, including:
a receiving module, configured to receive configuration information of a reference signal, wherein the configuration information includes: combined configuration information indicating a combined configuration; wherein the combined configuration includes: a set of IEs for indicating a resource set of a reference signal.

According to a fifth aspect of the present disclosure, a communication device is provided, the communication device including:
a processor; and
a memory for storing processor-executable instructions;
wherein the processor is configured to implement the information processing method of any embodiment of the present disclosure when running the executable instructions.

According to a sixth aspect of the present disclosure, a computer storage medium is provided, wherein the computer storage medium stores a computer executable program, and when the executable program is executed by a processor, the information processing method of any embodiment of the present disclosure is implemented.

It is to be understood that both the foregoing general description and the following detailed description are exemplary and explanatory only and are not restrictive of the embodiment of the present disclosure.

### BRIEF DESCRIPTION OF THE DRAWINGS

FIG. 1 is a schematic diagram of the structure of a wireless communication system.

FIG. 2 is a flow chart showing an information processing method according to an exemplary embodiment.

FIG. 3 is a flow chart showing an information processing method according to an exemplary embodiment.

FIG. 4 is a flow chart showing an information processing method according to an exemplary embodiment.

FIG. 5 is a flow chart showing an information processing method according to an exemplary embodiment.

FIG. 6 is a flow chart showing an information processing method according to an exemplary embodiment.

FIG. 7 is a block diagram showing an information processing apparatus according to an exemplary embodiment.

FIG. 8 is a block diagram showing an information processing apparatus according to an exemplary embodiment.

FIG. 9 is a block diagram of a UE according to an exemplary embodiment.

FIG. 10 is a block diagram of a base station according to an exemplary embodiment.

### DETAILED DESCRIPTION

Exemplary embodiments will be described in detail herein, examples of which are shown in the accompanying drawings. When the following description refers to the drawings, the same numbers in different drawings represent the same or similar elements unless otherwise indicated. The implementations described in the following exemplary embodiments do not represent all implementations consistent with the embodiments of the present disclosure. Instead, they are merely examples of devices and methods consistent with some aspects of the embodiments of the present disclosure as detailed in the appended claims.

The terms used in the embodiments of the present disclosure are only for the purpose of describing specific embodiments and are not intended to limit the embodiments of the present disclosure. The singular forms of “a” and “the” used in the embodiments of the present disclosure and the appended claims are also intended to include plural forms unless the context clearly indicates other meanings. It should also be understood that the term “and/or” used herein refers to and includes any or all possible combinations of one or more associated listed items.

It should be understood that although the terms first, second, third, etc. may be used to describe various information in the embodiments of the present disclosure, these information should not be limited to these terms. These terms are only used to distinguish the same type of information from each other. For example, without departing from the scope of the embodiments of the present disclosure, the first information may also be referred to as the second information, and similarly, the second information may also be referred to as the first information. Depending on the context, the word “if” as used herein may be interpreted as “at the time of” or “when” or “in response to determining”.

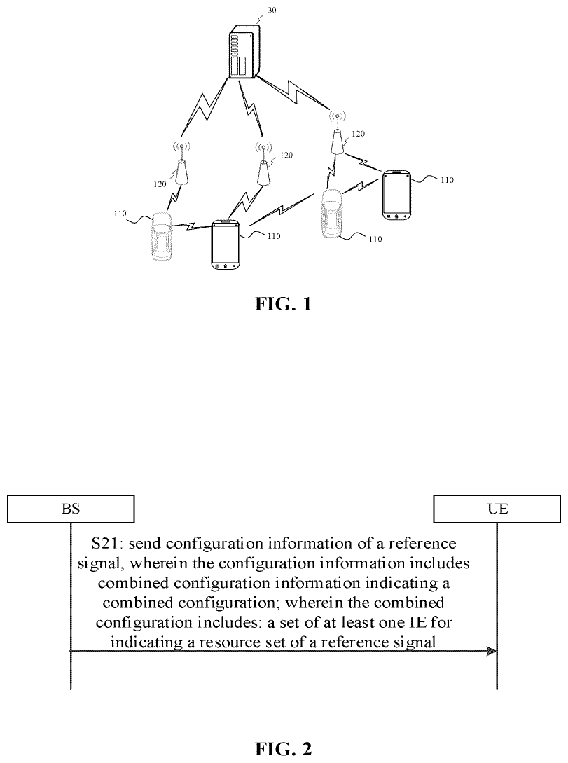

Please refer to FIG. 1, which shows a schematic diagram of the structure of a wireless communication system provided by an embodiment of the present disclosure. As shown in FIG. 1, the wireless communication system is a communication system based on cellular mobile communication technology, and the wireless communication system may include: a plurality of user equipment 110 and a plurality of base stations 120.

In the embodiment, the user equipment 110 can be a device that provides voice and/or data connectivity to the user. The user equipment 110 can communicate with one or more core networks via a radio access network (RAN). The user equipment 110 can be an Internet of Things user equipment, such as a sensor device, a mobile phone (or a “cellular” phone), and a computer with an Internet of Things user equipment. For example, it can be a fixed, portable, pocket-sized, handheld, computer-built-in or vehicle-mounted device. For example, a station (STA), a subscriber unit, a subscriber station, a mobile station, a mobile, a remote station, an access point, a remote terminal, an access terminal, a user terminal, a user agent, a user device, or a user equipment. Alternatively, the user equipment 110 can also be a device of an unmanned aerial vehicle. Alternatively, the user equipment 110 can also be a vehicle-mounted device, for example, it can be a driving computer with wireless communication function, or a wireless user device connected to a driving computer. Alternatively, the user equipment 110 may also be a roadside device, for example, a street lamp, a signal lamp, or other roadside device with a wireless communication function.

The base station 120 may be a network-side device in a wireless communication system. The wireless communication system may be a fourth generation mobile communication technology (4G) system, also known as a long term evolution (LTE) system; or, the wireless communication system may be a 5G system, also known as a new air interface system or a 5G NR system. Alternatively, the wireless communication system may be a next generation system of the 5G system. The access network in the 5G system may be referred to as a new generation radio access network (NG-RAN).

In the embodiment, the base station 120 can be an evolved base station (eNB) adopted in a 4G system. Alternatively, the base station 120 can also be a base station (gNB) adopting a centralized distributed architecture in a 5G system. When the base station 120 adopts a centralized distributed architecture, it usually includes a centralized unit (CU) and at least two distributed units (DU). The centralized unit is provided with a protocol stack of a media access control (MAC) layer, a radio link layer control protocol (RLC) layer, and a packet data convergence protocol (PDCP) layer; the distributed unit is provided with a physical (PHY) layer protocol stack. The embodiment of the present disclosure does not limit the specific implementation method of the base station 120.

A wireless connection may be established between the base station 120 and the user equipment 110 via a wireless air interface. In different implementations, the wireless air interface is a wireless air interface based on the fourth generation mobile communication network technology (4G) standard; or, the wireless air interface is a wireless air interface based on the fifth generation mobile communication network technology (5G) standard, for example, the wireless air interface is a new air interface; or, the wireless air interface may also be a wireless air interface based on the next generation mobile communication network technology standard of 5G.

In some embodiments, an E2E (End to End) connection may also be established between the user devices 110. For example, the application scenarios in the vehicle to everything (V2X) communication such as a vehicle to vehicle (V2V) communication, vehicle-to-infrastructure (V2I) communication and vehicle-to-pedestrian (V2P) communication.

Here, the above-mentioned user equipment can be considered as the terminal device of the following embodiments.

In some embodiments, the wireless communication system may further include a network management device 130.

Several base stations 120 are respectively connected to the network management device 130. The network management device 130 may be a core network device in a wireless communication system, for example, the network management device 130 may be a mobility management entity (MME) in an evolved packet core (EPC). Alternatively, the network management device may also be other core network devices, such as a serving gateway (SGW), a public data network gateway (PGW), a policy and charging rules function (PCRF), or a home subscriber server (HSS). The embodiment of the present disclosure does not limit the implementation form of the network management device 130.

In order to facilitate the understanding of those skilled in the art, the embodiments of the present disclosure enumerate multiple implementation methods to clearly illustrate the technical solutions of the embodiments of the present disclosure. Of course, those skilled in the art can understand that the multiple embodiments provided by the embodiments of the present disclosure can be executed separately, or can be executed together with the methods of other embodiments of the embodiments of the present disclosure, or can be executed together with some methods in other related technologies separately or in combination; the embodiments of the present disclosure do not limit this.

In order to better understand the technical solution described in any embodiment of the present disclosure, first, the configuration of the configuration information of the TRS or CSI-RS in the related art is partially described:

In one embodiment, the configuration information of TRS or CSI-RS is carried in the SIB, as shown in the following example:

```
  TRS-ResourceSetConfig::= SEQUENCE (SIZE (1..64)) OF TRS-ResourceSet
  TRS-ResourceSet::= SEQUENCE {
```

| | |
|---|---|
| TRS-ResourceSetId | TRS-ResourceSetId, |
| frequencyDomainAllocation | INTEGER (0..3), |
| numofslot | ENUMERATED {1,2}, |
| startingRB | INTEGER (0..274), |
| nrofRBs | INTEGER (24..276), |
| periodicityAndOffset | IDLETRS-ResourcePeriodicityAndOffset, |
| firstOFDMSymbolInTimeDomain | INTEGER (0..9), |
| powerControlOffsetSS | ENUMERATED {−3dB, 0dB, 3dB, 6dB}, |
| ssb-index | INTEGER (0..63), |
| indBitID | INTEGER (0..5), |
| scramblingID | SEQUENCE (SIZE (1..4)) OF ScramblingId |

}

| | |
|---|---|
| TRS-ResourceSetId::= | INTEGER (0..64-1) |
| ScramblingId ::= | INTEGER(0..1023) |
| IDLETRS-ResourcePeriodicityAndOffset ::= | CHOICE { |
| slots10 | INTEGER (0..9), -- CondSCS15KHZ |
| slots20 | INTEGER (0..19), -- CondSCS15or30KHZ |
| slots40 | INTEGER (0..39), -- CondSCS15or30or60KHZ |
| slots80 | INTEGER (0..79), -- |

CondSCS15or30or60or120KHZ
}.

In one embodiment, as shown in Table 1 below, an example is given of the number of bits required for each parameter in TRS configuration information; wherein the parameter includes but is not limited to at least one of: TRS resource set identifier (TRS-ResourceSetId), frequency domain resource location allocation (frequencyDomainAllocation), number of time slots (numofslot), starting resource block (startingRB), number of resource blocks (nrofRBs), periodicity and offset (periodicityAndOffset), first OFDM symbol in time domain (firstOFDMSymbolInTimeDomain), and power control offset (powerControlOffsetSS), synchronization signal block index (ssb-index), indicator bit identifier (indBitID), scrambling identifier (scramblingID) and total number of bits (Size in total).

TABLE 1

| Parameter | Number of bits required |
|---|---|
| TRS-ResourceSetId | 6 |
| frequencyDomainAllocation | 2 |
| numofslot | 1 |
| startingRB | 9 |
| nrofRBs | 9 |
| periodicityAndOffset | 9 |
| firstOFDMSymbolInTimeDomain | 4 |
| powerControlOffsetSS | 2 |
| ssb-index | 6 |
| indBitID | 3 |
| scramblingID | In the case of each TRS resource |
| | set, it can be 10 bits; in the |
| | case of each TRS resource, it |
| | can be 10 × 4 = 40 bits. |
| Size in total | In the case that each TRS resource |
| | set is scrambled, it can be 65 bits; |
| | in the case that each TRS resource |
| | is scrambled, it can be 95 bits. |

In one embodiment, indBitID can be used to indicate which resource set group (TRS resource set group) a TRS resource set is assigned to. If each TRS resource set is 65 bits or 95 bits, the total number of bits of the TRS configuration information can be: 65×64=4160 bits, or 95×64=6080 bits. In this way, the number of bits of the TRS configuration information is much larger than the number of bits that the SIB block can bear, which is about 2800 bits.

As shown in FIG. 2, an embodiment of the present disclosure provides an information processing method, which is executed by a base station and includes:

Step S21: send configuration information of a reference signal, wherein the configuration information includes combined configuration information indicating a combined configuration; wherein the combined configuration includes: a set of at least one IE for indicating a resource set of a reference signal.

In one embodiment, the base station may be various types of base stations; for example, a 3G base station, a 4G base station, a 5G base station or other evolved base stations.

The information processing method of the embodiment of the present disclosure may also be executed by a network device, which may be other access network devices or core network devices. If the information processing method is executed by a core network device, it may be that the core network device sends the configuration information of the reference signal to the base station, and the base station forwards the configuration information of the reference signal to the UE, etc.

The step S21 may be: the base station sends configuration information of the reference signal to the UE.

In one embodiment, the UE may be various mobile terminals or fixed terminals. For example, the UE may be, but is not limited to, a mobile phone, a computer, a server, a wearable device, a game control console, or a multimedia device.

The step S21 may be: the base station sends system information, where the system information carries configuration information of the reference signal.

In one embodiment, the system information may be a SIB-X.

Exemplarily, the SIB-X may be a SIB already specified in the wireless communication protocol or a newly added SIB. For example, the SIB-X may be the SIB1, SIB2, SIB3, SIB4, SIB5, SIB6, or SIB11, SIB12, etc. In this way, the embodiments of the present disclosure may carry the availability indication of the configuration of the reference signal in the existing SIB of the wireless communication protocol.

Exemplarily, the SIB-X may be a predetermined SIB. For example, the SIB-X may be the SIB15, SIB16 or SIB20, etc. In this way, the embodiment of the present disclosure may carry the configuration information of the reference signal by newly defining a type of SIB.

In one embodiment, the reference signal includes but is not limited to at least one of the following: TRS, and CSI-RS.

In one embodiment, the combined configuration includes: a set of at least one IE for indicating parameters in a resource set of a reference signal. Here, the combined configuration may include one or more IEs; the IE may correspond to one resource set or multiple resource sets.

Here, the resource set of the reference signal includes but is not limited to the resource set of TRS and/or CSI-RS.

Here, the parameters in the resource set, for example, the IE of the parameters in the resource set of the reference signal include but are not limited to at least one of: TRS resource set identifier (TRS-ResourceSetId), frequency domain resource location allocation (frequencyDomainAllocation), number of time slots (numofslot), starting resource block (startingRB), number of resource blocks (nrofRBs), periodicity and offset (periodicity AndOffset), first OFDM symbol in time domain (firstOFDMSymbolInTimeDomain), power control offset (powerControlOffsetSS), synchronization signal block index (ssb-index), indication bit identifier (indBitID), scrambling identifier (scramblingID) and total number of bits (Size in total).

Here, the resource set is a set of one or more of the above parameters. In the embodiments of the present disclosure, a plurality of means two or more than two; multiple means two or more than two.

Here, the IE may be, but is not limited to, the IE of the above parameters.

Here, the combined configuration may be a set of at least one IE. For example, the combined configuration may be a set of IEs of frequencyDomainAllocation, numofslots, startingRB, and nrofRBs.

Here, the combined configuration information is used to indicate a combined configuration; that is, the combined configuration information is used to indicate a set of at least one IE.

Here, the combined configuration may be a set of at least one IE of at least part of the resource set. Here, the set of IEs included in the combined configuration may be a common IE of multiple resource sets. For example, the network device configures N resource sets, namely resource set 0, resource set 1, . . . , resource set N−1; wherein N is an integer greater than 0. If the configurations of the IEs indicating frequencyDomainAllocation and numofslots in resource set 0, resource set 1, and resource set 2 are the same, the IEs of requencyDomainAllocation and numofslots may be used as a combined configuration.

In an embodiment of the present disclosure, configuration information of a reference signal may be sent through a base station, wherein the configuration information includes combined configuration information indicating a combined configuration, wherein the combined configuration includes: a set of at least one IE for indicating a resource set of a reference signal. In this way, the embodiment of the present disclosure may transmit a combined configuration for common parameters in the indication resource set, thereby reducing the number of bits occupied by the configuration information; in this way, when system information (such as SIB) is used to transmit the configuration information of the reference signal, it is not necessary to send the configuration information segmented for system information, thereby reducing the signaling overhead of the system information, etc.

The embodiment of the present disclosure provides an information processing method, which is executed by a base station, including: sending configuration information of a reference signal, wherein the configuration information includes: at least one configuration identifier (ID); wherein the configuration ID is associated with a combined configuration. For example, the configuration information includes: a configuration ID associated with the combined configuration or multiple configuration IDs associated with the combined configuration.

In one embodiment, the configuration identifier is a TRS configuration identifier (TRS-configuration Id).

In some embodiments, one combined configuration is associated with one configuration ID.

Exemplarily, a combined configuration may be a set of IEs of frequencyDomainAllocation, numofslot, startingRB, and nrofRBs; if a combined configuration is associated with a configuration ID. For example, a configuration ID associated with a combined configuration is configuration-ID0, which may indicate that the indication of the IE of frequencyDomainAllocation in the combined configuration is 1, the indication of the IE of numofslot is 2, the indication of the IE of startingRB is 3, and the indication of nrofRBs is 4. Of course, it should be understood that the above combined configuration is only an example, and the set of IEs in the combined configuration is not limited thereto.

In this way, a configuration method of parameters in a combined configuration can be implemented by associating a combined configuration with a configuration ID.

In some other embodiments, a combined configuration is used to configure at least one entity or to configure an entity list, wherein an entity list includes at least one entity. Here, one entity is associated with one configuration ID.

Here, one entity may correspond to a set of at least one IE in at least one resource set.

Exemplarily, a combined configuration may be a set of IEs of frequencyDomainAllocation, numofslot, startingRB, and nrofRBs; if a combined configuration is used to configure multiple entities, one entity is associated with one configuration ID. For example, there are three entities, and the configuration IDs associated with the three entities are configuration-ID0, configuration-ID1, and configuration-ID2 respectively; if the configuration ID is configuration-ID0, it can indicate that the indication of the IE of frequencyDomainAllocation in the combined configuration is 1, the indication of the IE of numofslot is 2, the indication of the IE of startingRB is 3, and the indication of nrofRBs is 4; if the configuration ID is configuration-ID1, it can indicate that the indication of the IE of frequencyDomainAllocation in the combined configuration is 2, the indication of the IE of numofslot is 3, the indication of the IE of startingRB is 4, and the indication of nrofRBs is 5; if the configuration ID is configuration-ID2, it can indicate that the indication of the IE of frequencyDomainAllocation in the combined configuration is 2, the indication of the IE of numofslot is 2, the indication of the IE of startingRB is 4, and the indication of nrofRBs is 4. Here, one entity can correspond to a configuration method of parameters in a combined configuration.

For example, in a possible implementation, assuming that specific IEs: frequencyDomainAllocation, numofslot, startingRB, nrofRBs are extracted and combined into a group named TRS-configuration, the configuration can be performed as follows:

| TRS-configuration { | |
|---|---|
| trs-configurationId | TRS-configurationId, |
| frequencyDomainAllocation | INTEGER (0..3), |
| numofslot | ENUMERATED {1,2}, |
| startingRB | INTEGER (0..274), |
| nrofRBs | INTEGER (24..276), |

}.

In this way, multiple entities can be configured through a combined configuration, and a configuration ID can be associated with an entity, thereby realizing multiple configuration methods of parameters in a combined configuration.

Exemplarily, a combined configuration may be a set of IEs of requencyDomainAllocation, numofslots, startingRB, and nrofRBs; if a combined configuration is used to configure an entity list, the entity list includes at least one entity. For example, the entity list includes three entities, such as TRS-configuration-ID1, TRS-configuration-ID2, and TRS-configuration-ID3; then an entity corresponds to a configuration mode of parameters in the combined configuration, e.g., TRS-configuration-ID1 may correspond to combined configuration 1 (TRS-configuration1), TRS-configuration-ID2 may correspond to combined configuration 2 (TRS-configuration2), and TRS-configuration-ID3 may correspond to combined configuration 3 (TRS-configuration3). In the embodiment, TRS-configuration1 can be used to indicate that the indication of the IE of frequencyDomainAllocation in the combined configuration is 1, the indication of the IE of numofslot is 2, the indication of the IE of startingRB is 3, and the indication of nrofRBs is 4; TRS-configuration2 can be used to indicate that the indication of the IE of frequencyDomainAllocation in the combined configuration is 2, the indication of the IE of numofslot is 3, the indication of the IE of startingRB is 4, and the indication of nrofRBs is 5; and TRS-configuration3 can be used to indicate that the indication of the IE of frequencyDomainAllocation in the combined configuration is 2, the indication of the IE of numofslot is 2, the indication of the IE of startingRB is 4, and the indication of nrofRBs is 4.

For example, the configuration can be performed as follows:

TRS-ResourceSetConfig::= SEQUENCE (SIZE (1..64)) OF TRS-ResourceSet

| | |
|---|---|
| TRS-ResourceSet::= SEQUENCE { | |
| TRS-configuration | TRS-configurationId ; |
| ssb-index | INTEGER (0..63), |
| indBitID | INTEGER (0..5), |

...

| | |
|---|---|
| scramblingID | SEQUENCE (SIZE (1..4)) OF ScramblingId |

}.

In this way, an entity list can be configured through a combined configuration, wherein one entity list includes multiple entities; and a configuration ID can be associated with an entity, thereby realizing multiple configuration modes of parameters in a combined configuration.

In this way, the entity list can be considered as a candidate configuration set. When the resource set is subsequently configured, these candidate configuration sets can be directly configured, thereby saving signaling overhead.

It should be noted that those skilled in the art can understand that the method provided in the embodiments of the present disclosure can be executed alone or together with some methods in the embodiments of the present disclosure or some methods in related technologies.

In some embodiments, the configuration information includes: indication information for indicating a single IE that is not configured in the combined configuration.

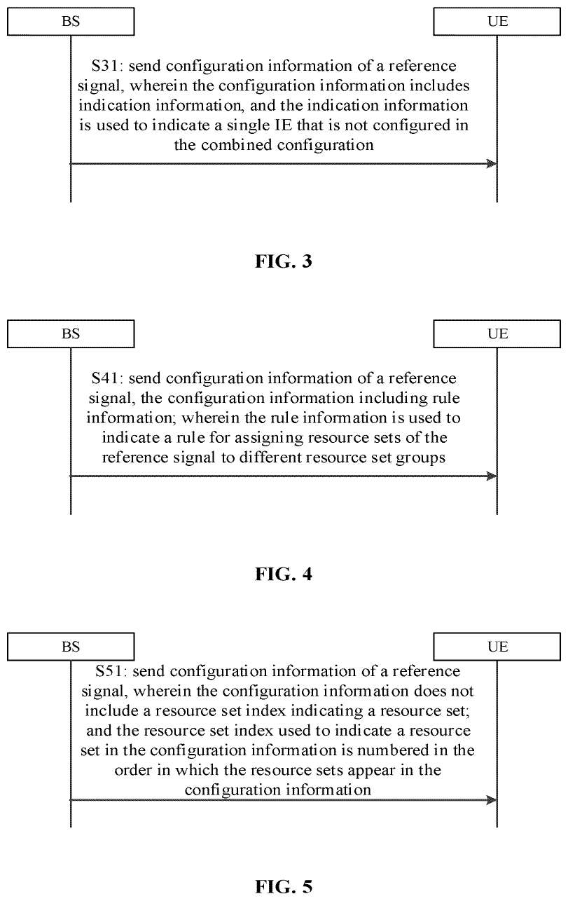

As shown in FIG. 3, an embodiment of the present disclosure provides an information processing method, which is executed by a base station and includes:

Step S31: send configuration information of a reference signal, wherein the configuration information includes indication information, and the indication information is used to indicate a single IE that is not configured in the combined configuration.

In one embodiment, the configuration information includes one or more pieces of indication information, wherein one piece of indication information is used to indicate an IE that is not configured in the combined configuration.

Exemplarily, among multiple resource sets configured by the network, if the parameter ssb-index is configured differently in each resource set, the IE of ssb-index can be sent to the UE separately; for example, the IE of ssb-index is indicated by indication information 1. If the parameter indBitID is configured differently in each resource set, the IE of indBitID can be sent to the UE separately; for example, the IE of indBitID is indicated by indication information 2. If the parameter scramblingID is configured differently in each resource set, the IE of scramblingID can be sent to the UE separately; for example, the IE of scramblingID is indicated by indication information 3.

Thus, in the embodiment of the present disclosure, when the base station sends configuration information to the UE, for IEs that are not configured in the combined configuration, the configuration of the IE can be indicated by sending indication information of the IE; thus, the configuration information of the reference signal can be completely sent.

In the embodiment of the present disclosure, in the configuration information sent by the base station, the IE configured in the combined configuration can be indicated by the configuration ID; the IE not configured in the combined configuration needs to be indicated by the indication information indicating the IE. In this way, on the one hand, the configuration of the common IE can be sent through the combined configuration to reduce the signaling overhead; on the other hand, the IE without commonality can be sent separately, so as to achieve the integrity of the configuration information transmission.

It should be noted that those skilled in the art can understand that the method provided in the embodiments of the present disclosure can be executed alone or together with some methods in the embodiments of the present disclosure or some methods in related technologies.

In some embodiments, the configuration information includes: rule information; wherein the rule information is used to indicate rules for assigning resource sets of the reference signal to different resource set groups.

As shown in FIG. 4, an embodiment of the present disclosure provides an information processing method, which is executed by a base station and includes:

Step S41: send configuration information of a reference signal, the configuration information including rule information; wherein the rule information is used to indicate a rule for assigning resource sets of the reference signal to different resource set groups.

In some embodiments of the present disclosure, the configuration information also includes the configuration information in step S21. In some other embodiments of the present disclosure, the configuration information does not include the configuration information in step S21, but the configuration information includes rule information.

In some embodiments of the present disclosure, the reference signal is the reference signal in step S21.

In some embodiments of the present disclosure, the reference signal is the reference signal in the above embodiments; the resource set is the resource set in the above embodiments.

The step S41 may be: sending the configuration of the reference signal to the UE, the configuration information including rule information; wherein the rule information is used to indicate the rule for assigning resource sets of the reference signal to different resource set groups.

The step S41 may be: sending system information, wherein the system information includes configuration information of a reference signal; the configuration information includes the rule information. Here, the system information may be a SIB-X.

In some embodiments, the rule information includes a resource set index of part of the resource set and a resource set group index of a corresponding resource set group; and wherein,

The rule information is used to indicate that the resource set indicated by the resource set index and at least one previous resource set are assigned to the resource set group indicated by the resource set group index corresponding to the resource set index; or,

The rule information is used to indicate that the resource set indicated by the resource set index and at least one subsequent resource set are assigned to the resource set group indicated by the resource set group index corresponding to the resource set index; or,

The rule information is used to indicate that the resource set indicated by the resource set index and the resource set between the resource set indicated by the resource set index and the resource set indicated by the previous resource set index are assigned to the resource set group indicated by the resource set group index corresponding to the resource set index.

In one embodiment, the resource set index may be a TRS resource set index (TRS-ResourceSetId). The resource set group index may be a TRS resource set group index.

An embodiment of the present disclosure provides an information processing method, which is executed by a base station, including: sending configuration information of a reference signal, the configuration information including: rule information; wherein the rule information includes a resource set index of part of the resource set and a resource set group index of a corresponding resource set group; and the rule information is used to indicate that the resource set indicated by the resource set index and at least one previous resource set are assigned to the resource set group indicated by the resource set group index corresponding to the resource set index.

Exemplarily, if the network device is configured with 5 resource sets, the 5 resource sets are resource set 0, resource set 1, resource set 2, resource set 3 and resource set 4. The rule information sent by the base station includes: the resource set index “2” of resource set 2 and the resource set group index “0” of the corresponding resource set group 0, and the resource set index “4” of resource set 4 and the resource set group index “1” of the corresponding resource set group 1. Then the rule information is used to indicate that resource set 2 and at least one resource set before resource set 2 (such as resource set 0 and resource set 1) all are assigned to resource set group 0, and resource set 4 and at least one resource set before resource set 4 (such as resource set 3) all are assigned to resource set group 1. That is, the rule information is used to indicate that resource sets 0, 1 and 2 are assigned to resource set group 0, and resource sets 3 and 4 are assigned to resource set group 1.

An embodiment of the present disclosure provides an information processing method, which is executed by a base station, including: sending configuration information of a reference signal, the configuration information including: rule information; wherein the rule information includes a resource set index of part of the resource set and a resource set group index of a corresponding resource set group; and the rule information is used to indicate that the resource set indicated by the resource set index and at least one subsequent resource set are assigned to the resource set group indicated by the resource set group index corresponding to the resource set index.

Exemplarily, if the network device is configured with 5 resource sets, the 5 resource sets are resource set 0, resource set 1, resource set 2, resource set 3 and resource set 4. The rule information sent by the base station includes: the resource set index “0” of resource set 0 and the resource set group index “0” of the corresponding resource set group 0, and the resource set index “2” of resource set 2 and the resource set group index “1” of the corresponding resource set group 1. Then the rule information is used to indicate that: resource set 0 and at least one resource set after resource set 0 (such as resource set 1) all are assigned to resource set group 0, and resource set 2 and at least one resource set after resource set 2 (such as resource set 3 and resource set 4) all are assigned to resource set group 1. That is, the rule information is used to indicate that resource sets 0 and 1 are assigned to resource set group 0, and resource sets 2, 3 and 4 are assigned to resource set group 1.

An embodiment of the present disclosure provides an information processing method, which is executed by a base station, including: sending configuration information of a reference signal, the configuration information including: rule information; wherein the rule information includes a resource set index of part of the resource set and a resource set group index of a corresponding resource set group; and the rule information is used to indicate that the resource set indicated by the resource set index and the resource set between the resource set indicated by the resource set index and the resource set indicated by the previous resource set index are assigned to the resource set group indicated by the resource set group index corresponding to the resource set index.

Exemplarily, if the network device is configured with 5 resource sets, the 5 resource sets are resource set 0, resource set 1, resource set 2, resource set 3 and resource set 4. The rule information sent by the base station includes: the resource set index “2” of resource set 2 and the corresponding resource set group index “0” of resource set group 0, and the resource set index “4” of resource set 4 and the corresponding resource set group index “1” of resource set group 1. Then the rule information is used to indicate that: the resource set 2 and the resource sets before resource set 2 (such as resource set 0 and resource set 1) all are assigned to resource set group 0, and resource set 4 and the resource sets between resource set 2 and resource set 4 (such as resource set 3) all are assigned to resource set group 1. That is, the rule information is used to indicate that resource sets 0, 1 and 2 are assigned to resource set group 0, and resource sets 3 and 4 are assigned to resource set group 1.

In the embodiment of the present disclosure, the base station can carry the resource set index of part of the resource sets and the resource set group index of the corresponding resource set group through rule information, so as to realize assigning at least part of the resource sets to different resource set groups. Also, because the configuration information in the present application does not need to carry the resource set index of each resource set and the resource set group index of the resource set group corresponding to the resource set; thus, the number of bits of the configuration information can be reduced, and the signaling overhead can be reduced.

In some embodiments, the rule information includes a demarcation resource set index, the demarcation resource set index indicates a resource set serving as a demarcation point; and

The rule information is used to indicate that the resource set indicated by the next demarcation resource set index and the resource set between the resource set indicated by the next demarcation resource set index and the resource set indicated by the previous demarcation resource set index are assigned to the same resource set group; and/or,

The rule information is used to indicate that the resource sets following the resource set indicated by the last demarcation resource set index are assigned to the same resource set group.

An embodiment of the present disclosure provides an information processing method, which is executed by a base station, including: sending configuration information of a reference signal, the configuration information including: a demarcation resource set index, the demarcation resource set index indicating a resource set serving as a demarcation point; and rule information used to indicate that the resource set indicated by the next demarcation resource set index and the resource set between the resource set indicated by the previous demarcation resource set index and the resource set indicated by the next demarcation resource set are assigned to the same resource set group, and is used to indicate that the resource set after the resource set indicated by the last demarcation resource set index is assigned to the same resource set group.

In one embodiment, the rule information may include: at least one demarcation resource set index. Here, resource sets indicated by different demarcation resource set indexes are assigned to different resource set groups.

In one embodiment, the rule information may include: an index list, wherein the index list includes one or more demarcation resource set indexes.

Exemplarily, the base station configuration information includes an index list; the index list includes 3 demarcation resource set indexes, namely “index1”, “index2” and “index3”. The rule indication information is used to indicate: the resource set indicated by “index1” and the resource set before the resource set indicated by “index1” are assigned to the first resource set group (such as group0); the resource set indicated by “index2” and the resource set between the resource set indicated by “index2” and the resource set indicated by “index1” are assigned to the second resource set group (such as group1); the resource set indicated by “index3” and the resource set between the resource set indicated by “index3” and the resource set indicated by “index2” are assigned to the third resource set group (such as group3); and the resource set after the resource set indicated by “index3” is assigned to the fourth set group (such as group4). If the network device is configured with 10 resource sets, which are resource set 0, resource set 1, resource set 2, resource set 3, . . . , and resource set 9. The rule information sent by the base station includes the above three demarcation resource set indexes: “index1”, “index2” and “index3”, wherein “index1” is used to indicate resource set 2 as the demarcation point, “index2” is used to indicate resource set 4 as the demarcation point, and “index3” is used to indicate resource set 6 as the demarcation point. Then the rule information is used to indicate that resource sets 0, 1 and 2 are assigned to the first resource set group (such as group0), resource sets 3 and 4 are assigned to the second resource set group (such as group1), resource sets 5 and 6 are assigned to the third resource set group (such as group2), and resource sets 7, 8 and 9 are assigned to the fourth resource set group (such as group3).

Here, if the rule information includes N demarcation resource set indexes, then the number of resource set groups is N+1; wherein N is an integer greater than 0.

In the embodiment of the present disclosure, the base station can carry the demarcation resource set index through the rule information, so that the resource set indicated by the demarcation resource set index is used as the demarcation point, so as to realize that at least part of the resource sets are assigned to different resource set groups. Also, because the configuration information in the present application only needs to carry the demarcation resource set index of the resource set as the demarcation point, it is not necessary to carry the resource set index of each resource set and the resource set group index of the resource set group corresponding to the resource set; thereby, the number of bits of the configuration information can be reduced, and the signaling overhead can be reduced.

In some embodiments, the rule information includes: the number of resource set groups; and the rule information is used to indicate that the resource sets are evenly assigned into different resource set groups, and/or to indicate that if the number of resource sets is not divisible by the number of resource set groups, the remaining resource sets shall be assigned to any resource set group.

The embodiment of the present disclosure provides an information processing method, which is executed by a base station, including: sending configuration information of a reference signal, the configuration information including: the number of resource set groups; and rule information is used to indicate that the resource sets are evenly assigned into different resource set groups.

Exemplarily, if the network device is configured with 30 resource sets, the 30 resource sets are resource set 0, resource set 1, resource set 2, . . . , resource set 29. The rule information sent by the base station includes: the number of resource set groups is 6; then the rule information indicates that the 30 resource sets are evenly assigned into the 6 resource set groups. For example, resource sets 0 to 4 are assigned into resource set group 0, resource sets 5 to 9 are assigned into resource set group 1, resource sets 10 to 14 are assigned into resource set group 2, resource sets 15 to 19 are assigned into resource set group 3, resource sets 20 to 24 are assigned into resource set group 4, and resource sets 25 to 29 are assigned into resource set group 5.

An embodiment of the present disclosure provides an information processing method, which is executed by a base station, including: sending configuration information of a reference signal, the configuration information including: the number of resource set groups; and rule information is used to indicate that resource sets are evenly assigned into different resource set groups, or to indicate that if the number of resource sets is not divisible by the number of resource set groups, the remaining resource sets are assigned to any one of the resource set groups.

Exemplarily, if the network device is configured with 33 resource sets, the 33 resource sets are respectively resource set 0, resource set 1, resource set 2, . . . , resource set 32. The rule information sent by the base station includes: the number of resource set groups is 6; when the 32 resource set groups are not divisible by the 6 resource set groups, the rule information indicates that 30 resource sets among the 32 resource sets are evenly assigned into 6 resource set groups, and the remaining 3 resource sets that are not divisible are assigned to any one of the 6 resource set groups, for example, they are assigned to the last resource set group. For example, resource sets 0 to 4 are assigned into resource set group 0, resource sets 5 to 9 are assigned into resource set group 1, resource sets 10 to 14 are assigned into resource set group 2, resource sets 15 to 19 are assigned into resource set group 3, resource sets 20 to 24 are assigned into resource set group 4, and resource sets 25 to 29 and 30 to 32 (i.e., resource sets 25 to 32) are assigned into resource set group 5.

In the embodiment of the present disclosure, the base station can carry the number of resource set groups through rule information, so that at least part of the resource sets are evenly assigned to the resource set groups, or when the number is not divisible, the remaining resource set groups are additionally assigned to any resource set group. In this way, when the configuration information only carries the number of resource groups, at least part of the resource sets can be assigned to different resource set groups; in this way, the number of bits occupied by the configuration information can be reduced, thereby reducing the signaling overhead.

It should be noted that those skilled in the art can understand that the method provided in the embodiments of the present disclosure can be executed alone or together with some methods in the embodiments of the present disclosure or some methods in related technologies.

In some embodiments, the configuration information does not include: a resource set index indicating a resource set; the configuration information is also used to indicate: the resource set index of the resource set is numbered according to the order in which the resource sets appear in the configuration information.

It should be understood that the above embodiments may be implemented individually or in combination with one or more of the above embodiments, and the present disclosure does not limit this.

As shown in FIG. 5, an embodiment of the present disclosure provides an information processing method, which is executed by a base station and includes:

Step S51: send configuration information of a reference signal, wherein the configuration information does not include a resource set index indicating a resource set; and the resource set index used to indicate a resource set in the configuration information is numbered in the order in which the resource sets appear in the configuration information.

In one embodiment, the resource set index is a TRS resource set index (TRS-ResourceSet ID).

For example, if the configuration information includes 10 resource sets, and TRS-ResourceSet ID does not exist in each resource set, the configuration information is used to indicate that the resource set index of each resource set is cumulatively numbered in the order in which each resource set appears in the configuration information. For example, if resource set 0 to resource set 9 appear in the configuration information in sequence, the resource set indexes of resource set 0 to resource set 9 are “index0” to “index9” respectively.

In an embodiment of the present disclosure, the base station can transmit configuration information that does not carry a resource set index to indicate that each resource set is numbered based on the order in which it appears in the configuration information to obtain a resource set index; in this way, indexing of each resource set can be achieved without additionally sending a resource set index, thereby also reducing the proportion of configuration information and thereby reducing signaling overhead.

It should be noted that those skilled in the art can understand that the method provided in the embodiments of the present disclosure can be executed alone or together with some methods in the embodiments of the present disclosure or some methods in related technologies.

The following information processing method is executed by the UE, which is similar to the description of the information processing method executed by the base station mentioned above; and for technical details not disclosed in the embodiment of the information processing method executed by the UE, please refer to the description of the example of the information processing method executed by the base station, and no detailed description is given here.

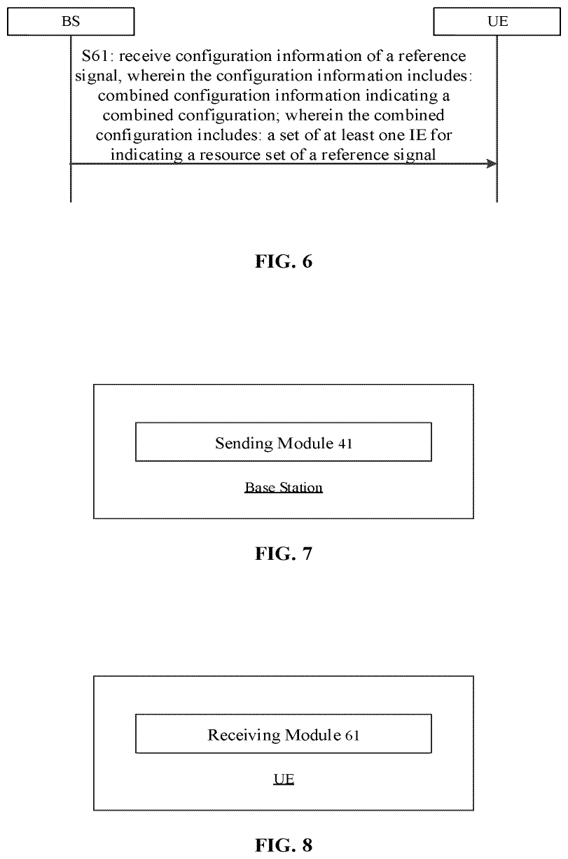

As shown in FIG. 6, an embodiment of the present disclosure provides an information processing method, which is executed by a UE and includes:

Step S61: receive configuration information of a reference signal, wherein the configuration information includes: combined configuration information indicating a combined configuration; wherein the combined configuration includes: a set of at least one IE for indicating a resource set of a reference signal.

In one embodiment, the combined configuration includes: a set of at least one IE for indicating a parameter in a resource set of a reference signal.

In some embodiments of the present disclosure, the configuration information may be the configuration information in the above embodiments; the combined configuration may be the combined configuration in the above embodiments; the IE may be the IE in the above embodiments; and the parameters may be the parameters in the above embodiments.

Exemplarily, the reference signal includes, but is not limited to, at least one of the following: TRS, and CSI-RS.

Exemplarily, the parameters include, but are not limited to, at least one of the following: TRS-ResourceSetId, frequencyDomainAllocation, numofslot, startingRB, nrofRBs, periodicityAndOffse, firstOFDMSymbolInTimeDomain, powerControlOffsetSS, ssb-index, indBitID, scramblingID, and Size in total.

Exemplarily, the resource set is a set of one or more of the above parameters.

Exemplarily, the IE is one or more of the above parameters.

Exemplarily, the combined configuration may be a set of at least one IE.

The step S61 may be: the UE receives configuration information of a reference signal sent by the base station.

The step S61 may be: the UE receives system information, the system information carries the configuration information, and the system information may be a SIB-X.

In some embodiments, the configuration information includes: at least one configuration ID.

In some embodiments, one combined configuration is associated with one configuration ID.

In other embodiments, a combined configuration is used to configure at least one entity or to configure an entity list; wherein an entity list includes at least one entity; wherein one entity is associated with one configuration ID.

An embodiment of the present disclosure provides an information processing method, which is executed by a UE, and includes: receiving configuration information of a reference signal, wherein the configuration information includes indication information, and the indication information is used to indicate a single IE that is not configured in a combined configuration.

An embodiment of the present disclosure provides an information processing method, which is executed by a UE, and includes: receiving configuration information of a reference signal, wherein the configuration information includes: rule information; wherein the rule information is used to indicate a rule for assigning resource sets to different resource set groups.

An embodiment of the present disclosure provides an information processing method, which is executed by a UE, and includes: receiving configuration information of a reference signal, wherein the configuration information includes: rule information; wherein the rule information includes a resource set index of part of the resource set and a resource set group index of a corresponding resource set group; and the rule information is used to indicate that the resource set indicated by the resource set index and at least one previous resource set are assigned to the resource set group indicated by the resource set group index corresponding to the resource set index.

An embodiment of the present disclosure provides an information processing method, which is executed by a UE, and includes: receiving configuration information of a reference signal, wherein the configuration information includes: rule information; wherein the rule information includes a resource set index of part of the resource set and a resource set group index of a corresponding resource set group; and the rule information is used to indicate that the resource set indicated by the resource set index and at least one subsequent resource set are assigned to the resource set group indicated by the resource set group index corresponding to the resource set index.

An embodiment of the present disclosure provides an information processing method, which is executed by a UE, and includes: receiving configuration information of a reference signal, wherein the configuration information includes: rule information; wherein the rule information includes a resource set index of part of the resource set and a resource set group index of a corresponding resource set group; and the rule information is used to indicate that a resource set indicated by the resource set index and a resource set between the resource set indicated by the resource set index and the resource set indicated by the previous resource set index are assigned to the resource set group indicated by the resource set group index corresponding to the resource set index.

An embodiment of the present disclosure provides an information processing method, which is executed by a UE, and includes: receiving configuration information of a reference signal, wherein the configuration information includes: rule information; the rule information includes a demarcation resource set index, and the demarcation resource set index indicates a resource set serving as a demarcation point; and the rule information is used to indicate that the resource set indicated by the next demarcation resource set index and the resource set between the resource set indicated by the previous demarcation resource set index and the resource set indicated by the next demarcation resource set index are assigned to the same resource set group; and/or, the rule information is used to indicate that the resource set after the resource set indicated by the last demarcation resource set index is assigned to the same resource set group.

An embodiment of the present disclosure provides an information processing method, which is executed by a UE, including: receiving configuration information of a reference signal, wherein the configuration information includes: rule information; the rule information includes the number of resource set groups; and the rule information is used to indicate that resource sets are evenly assigned into different resource set groups, and/or to indicate that if the number of resource sets is not divisible by the number of resource set groups, the remaining resource sets are assigned to any one of the resource set groups.

An embodiment of the present disclosure provides an information processing method, which is executed by a UE, and includes: receiving configuration information of a reference signal, wherein the configuration information does not include: a resource set index indicating a resource set; the configuration information is used to indicate: the resource set index of the resource set is numbered according to the order in which the resource sets appear in the configuration information.

For the specific description of the configuration information, please refer to the description on the base station side, which will not be repeated here.

It should be noted that those skilled in the art can understand that the method provided in the embodiments of the present disclosure can be executed alone or together with some methods in the embodiments of the present disclosure or some methods in related technologies.

In order to further explain any embodiment of the present disclosure, a specific embodiment is provided below.

The present disclosure provides an information processing method, which is executed by a base station and includes:
Step S71: the base station sends configuration information of TRS and/or CSI-RS; and
Step S72: the base station sends a rule of a resource set group to which a TRS and/or CSI-RS resource set is assigned.
Step S72 includes the modes below.

Mode A: The base station assigns part of the resource sets to different resource set groups.

Here, the base station may transmit rule information carrying part of the resource sets assigned to different resource set groups. The resource set group to which a resource set is assigned is the same as the resource set group to which the previous resource set is assigned, or the resource set group to which a resource set is assigned is the same as the resource set group to which the next resource set is assigned.

For example, if the network device is configured with 5 resource sets, the 5 resource sets are resource set 0, resource set 1, resource set 2, resource set 3 and resource set 4; wherein the rule information configures resource set 2 to are assigned to resource set group 0, and resource set 4 to are assigned to resource set group 1, as shown below: Resource set 0,
Resource set 1,
Resource set 2, 0
Resource set 3,
Resource set 4,1;

It is considered that resource set 2 (including resource set 2, resource set 0 and resource set 1) are all assigned to resource set group 0; resource sets before resource set 4 to resource set 2 (including resource set 3 and resource set 4) are all assigned to resource set group 1.

Mode B: The base station provides a demarcation point for assigning part of the resource sets to different resource set groups.

Here, the base station transmits rule information carrying a demarcation resource set index serving as a demarcation point resource set.

Exemplarily, the rule information sent by the base station includes an index list, and the index list includes three demarcation resource set indexes “index1”, “index2” and “index3”. It is considered that the base station assigns the resource set before the resource set indicated by “index1” (including the resource set indicated by “index1”) to the first resource set group (group0), the resource set between the resource set indicated by “index1” and the resource set indicated by “index2” (including the resource set indicated by “index2”) to the second resource set group (group1), the resource set between the resource set indicated by “index2” and the resource set indicated by “index3” (including the resource set indicated by “index3”) to the third resource set group (group2), and the remaining resource sets to the fourth resource set group (group3).

Here, the total number of resource set groups is: the number of demarcation resource set indexes in the index list provided by the base station plus 1.

Mode C: The base station assigns resource sets to different resource set groups.

Here, the base station sends rule information carrying the number of resource set groups. Here, if the number of resource set groups sent is N, and if the number of configured resource sets is divisible by N, the resource sets are evenly assigned into N resource set groups; if the configured resource sets is not divisible by N, the divisible part is first evenly assigned into N resource set groups, and the remainder part is assigned to the last resource set group.

In one embodiment, the rule information of the above modes A, B and C can all be carried in the configuration information.

Of course, in other implementation examples, the rule information of the above methods A, B and C can also be sent separately.

Step S73: the base station does not send the resource set index.

Here, the resource set index may be a TRS resource set index (TRS-ResourceSetId); if the base station does not send TRS-ResourceSet Id, the index of each set resource is numbered according to the order in which the resource sets appear in the configuration information.

Exemplarily, the resource set that appears first in the configuration information has an index of “0”; the resource set that appears second in the configuration information has an index of “1”; and the indexes are accumulated in sequence.

Step S74: the base station sends a combined configuration including a set of at least one IE to the UE;

Here, the base station sends combined configuration information of the combined configuration, wherein the combined configuration includes at least one IE. Here, the combined configuration information can be carried in the configuration information, or the combined configuration information can also be sent separately.

Here, the IE included in the combined configuration may be a specific IE; the IE is used to indicate a parameter in the resource set.

Step S74 includes the modes below.

Mode D: One combined configuration is associated with one configuration ID.

Exemplarily, the base station extracts specific IEs from the resource set, such as extracting the IEs of frequencyDomainAllocation, numofslot, startingRB, and nrofRBs as a combined configuration; the combined configuration is associated with a configuration ID. Therefore, when sending a resource set, its IE can be sent in the combined configuration; for example, as shown in the following example:

| TRS-configuration { | |
|---|---|
| TRS-configurationId | TRS-configurationId, |
| frequencyDomainAllocation | INTEGER (0..3), |
| numofslot | ENUMERATED {1,2}, |
| startingRB | INTEGER (0..274), |
| nrofRBs | INTEGER (24..276), |

}.

Mode E: A combined configuration configures multiple entities or an entity list; an entity list includes: multiple entities; one entity is associated with one configuration ID.

Exemplarily, the base station configures multiple configuration IDs for a combined configuration; for example, three configuration IDs are configures for a combined configuration, and the three configuration IDs are TRS-configuration-ID0, TRS-configuration-ID1, and TRS-configuration-ID2 respectively; the three configuration IDs identify the combined configuration, which may be: TRS-configuration-ID0 may indicate TRS-configuration1, TRS-configuration-ID1 may indicate TRS-configuration2, and/or TRS-configuration-ID2 may indicate TRS-configuration3. For example, each combined configuration is identified by a configuration ID, which may be as follows:

```
  {
  TRS-configuration1=» TRS-configuration-ID1;
  TRS-configuration2=» TRS-configuration-ID2;
  TRS-configuration3=» TRS-configuration-ID3
}.
```

Step S75: The base station sends a single IE that is not configured in the combined configuration.

Here, the base station sends indication information, which is used to indicate a single IE that is not configured in the combined configuration. The indication information can be carried in the configuration information and sent. Therefore, when sending a resource set, its IEs can be divided into two parts for sending, one is the IE that is already included in the combined configuration, and the other is the IE that is not configured in the combined configuration. The latter part can be sent directly, and for the IE in the combined configuration, it is only needed to send the index corresponding to the combined configuration entity. For example, as shown in the following example:

```
  TRS-ResourceSetConfig::= SEQUENCE (SIZE (1..64)) OF TRS-ResourceSet
  TRS-ResourceSet::= SEQUENCE {
```

| | |
|---|---|
| TRS-configuration | TRS-configurationId ; |
| ssb-index | INTEGER (0..63), |
| indBitID | INTEGER (0..5), |

...

| | |
|---|---|
| scramblingID | SEQUENCE (SIZE (1..4)) OF ScramblingId |

}.

It should be noted that those skilled in the art can understand that the method provided in the embodiments of the present disclosure can be executed alone or together with some methods in the embodiments of the present disclosure or some methods in related technologies.

FIG. 7, an embodiment of the present disclosure provides an information processing apparatus, which is applied to a base station, including:
a sending module 41, configured to send configuration information of a reference signal, wherein the configuration information includes: combined configuration information indicating a combined configuration; wherein the combined configuration includes: a set of at least one IE for indicating a resource set of a reference signal.

In one embodiment, the combined configuration includes: a set of at least one IE for indicating a parameter in a resource set of a reference signal.

An embodiment of the present disclosure provides an information processing apparatus, applied to a base station and including: a sending module 41, configured to send configuration information of a reference signal to a UE.

The embodiment of the present disclosure provides an information processing apparatus, which is applied to a base station, and includes: a sending module 41, which is configured to send system information, wherein the system information carries configuration information. The system information may be SIB-X.

In some embodiments, the configuration information includes: at least one configuration ID.

In some embodiments, one combined configuration is associated with one configuration ID.

In other embodiments, a combined configuration is used to configure at least one entity or to configure an entity list; wherein an entity list includes at least one entity; wherein one entity is associated with one configuration ID.

An embodiment of the present disclosure provides an information processing apparatus, which is executed by a base station, and includes: a sending module 41, configured to send configuration information of a reference signal, wherein the configuration information includes indication information, and the indication information is used to indicate a single IE that is not configured in a combined configuration.

An embodiment of the present disclosure provides an information processing apparatus, which is executed by a base station, and includes: a sending module 41, configured to send configuration information of a reference signal, wherein the configuration information includes: rule information; wherein the rule information is used to indicate a rule for assigning resource sets of the reference signal to different resource set groups.

An embodiment of the present disclosure provides an information processing apparatus, which is executed by a base station, and includes: a sending module 41, configured to send configuration information of a reference signal, wherein the configuration information includes: rule information; wherein the rule information includes a resource set index of part of the resource set and a resource set group index of a corresponding resource set group; and the rule information is used to indicate that the resource set indicated by the resource set index and at least one previous resource set are assigned to the resource set group indicated by the resource set group index corresponding to the resource set index.

An embodiment of the present disclosure provides an information processing apparatus, which is executed by a base station, and includes: a sending module 41, configured to send configuration information of a reference signal, wherein the configuration information includes: rule information; wherein the rule information includes a resource set index of part of the resource set and a resource set group index of a corresponding resource set group; and the rule information is used to indicate that the resource set indicated by the resource set index and at least one subsequent resource set are assigned to the resource set group indicated by the resource set group index corresponding to the resource set index.

An embodiment of the present disclosure provides an information processing apparatus, which is executed by a base station, and includes: a sending module 41, configured to send configuration information of a reference signal, wherein the configuration information includes: rule information; wherein the rule information includes a resource set index of part of the resource set and a resource set group index of a corresponding resource set group; and the rule information is used to indicate that a resource set indicated by the resource set index and a resource set between the resource set indicated by the resource set index and the resource set indicated by the previous resource set index are assigned to the resource set group indicated by the resource set group index corresponding to the resource set index.

An embodiment of the present disclosure provides an information processing apparatus, which is executed by a base station, and includes: a sending module 41, configured to send configuration information of a reference signal, wherein the configuration information includes: rule information; the rule information includes a demarcation resource set index, and the demarcation resource set index indicates a resource set serving as a demarcation point; and the rule information is used to indicate that the resource set indicated by the next demarcation resource set index and the resource set between the resource set indicated by the previous demarcation resource set index and the resource set indicated by the next demarcation resource set index are assigned to the same resource set group; and/or, the rule information is used to indicate that the resource set after the resource set indicated by the last demarcation resource set index is assigned to the same resource set group.

An embodiment of the present disclosure provides an information processing apparatus, which is executed by a base station, including: a sending module 41, configured to send configuration information of a reference signal, wherein the configuration information includes: rule information; the rule information includes the number of resource set groups; and the rule information is used to indicate that resource sets are evenly assigned into different resource set groups, and/or to indicate that if the number of resource sets is not divisible by the number of resource set groups, the remaining resource sets are assigned to any one of the resource set groups.

An embodiment of the present disclosure provides an information processing apparatus, which is executed by a base station, and includes: a sending module 41, configured to send configuration information of a reference signal, wherein the configuration information does not include: a resource set index indicating a resource set; the configuration information is used to indicate: the resource set index of the resource set is numbered according to the order in which the resource sets appear in the configuration information.

As shown in FIG. 8, an embodiment of the present disclosure provides an information processing apparatus, which is applied to a UE, including:
a receiving module 61, configured to receive configuration information of a reference signal, wherein the configuration information includes: combined configuration information indicating a combined configuration; wherein the combined configuration includes: a set of IEs indicating a resource set for indicating a reference signal.

An embodiment of the present disclosure provides an information processing device, applied to a UE, comprising: a receiving module 61, configured to receive configuration information of a reference signal sent by a base station.

An embodiment of the present disclosure provides an information processing apparatus, applied to a UE and including: a receiving module 61, configured to receive system information, wherein the system information carries configuration information. The system information may be SIB-X.

In some embodiments, the configuration information includes: at least one configuration ID.

In some embodiments, one combined configuration is associated with one configuration ID.

In other embodiments, a combined configuration is used to configure at least one entity or to configure an entity list; wherein an entity list includes at least one entity; wherein one entity is associated with one configuration ID.

An embodiment of the present disclosure provides an information processing apparatus, which is executed by a UE and including: a receiving module 61, configured to receive configuration information of a reference signal, wherein the configuration information includes indication information, and the indication information is used to indicate a single IE that is not configured in a combined configuration.

An embodiment of the present disclosure provides an information processing apparatus, which is executed by a UE and including: a receiving module 61, configured to receive configuration information of a reference signal, wherein the configuration information includes: rule information; wherein the rule information is used to indicate a rule for assigning resource sets of the reference signal to different resource set groups.

An embodiment of the present disclosure provides an information processing apparatus, which is executed by a UE and including: a receiving module 61, configured to receive configuration information of a reference signal, wherein the configuration information includes: rule information; wherein the rule information includes a resource set index of part of the resource set and a resource set group index of a corresponding resource set group; and the rule information is used to indicate that the resource set indicated by the resource set index and at least one previous resource set are assigned to the resource set group indicated by the resource set group index corresponding to the resource set index.

An embodiment of the present disclosure provides an information processing apparatus, which is executed by a base station, and includes: a UE and including: a receiving module 61, configured to receive configuration information of a reference signal, wherein the configuration information includes: rule information; wherein the rule information includes a resource set index of part of the resource set and a resource set group index of a corresponding resource set group; and the rule information is used to indicate that the resource set indicated by the resource set index and at least one subsequent resource set are assigned to the resource set group indicated by the resource set group index corresponding to the resource set index.

An embodiment of the present disclosure provides an information processing apparatus, which is executed by a UE and including: a receiving module 61, configured to receive configuration information of a reference signal, wherein the configuration information includes: rule information; wherein the rule information includes a resource set index of part of the resource set and a resource set group index of a corresponding resource set group; and the rule information is used to indicate that a resource set indicated by the resource set index and a resource set between the resource set indicated by the resource set index and the resource set indicated by the previous resource set index are assigned to the resource set group indicated by the resource set group index corresponding to the resource set index.

An embodiment of the present disclosure provides an information processing apparatus, which is executed by a UE and including: a receiving module 61, configured to receive configuration information of a reference signal, wherein the configuration information includes: rule information; the rule information includes a demarcation resource set index, and the demarcation resource set index indicates a resource set serving as a demarcation point; and the rule information is used to indicate that the resource set indicated by the next demarcation resource set index and the resource set between the resource set indicated by the previous demarcation resource set index and the resource set indicated by the next demarcation resource set index are assigned to the same resource set group; and/or, the rule information is used to indicate that the resource set after the resource set indicated by the last demarcation resource set index is assigned to the same resource set group.

An embodiment of the present disclosure provides an information processing apparatus, which is executed by a UE and including: a receiving module 61, configured to receive configuration information of a reference signal, wherein the configuration information includes: rule information; the rule information includes the number of resource set groups; and the rule information is used to indicate that resource sets are evenly assigned into different resource set groups, and/or to indicate that if the number of resource sets is not divisible by the number of resource set groups, the remaining resource sets are assigned to any one of the resource set groups.

An embodiment of the present disclosure provides an information processing apparatus, which is executed by a UE and including: a receiving module 61, configured to receive configuration information of a reference signal, wherein the configuration information does not include: a resource set index indicating a resource set; the configuration information is used to indicate: the resource set index of the resource set is numbered according to the order in which the resource sets appear in the configuration information.

It should be noted that those skilled in the art can understand that the apparatus provided in the embodiments of the present disclosure can be executed alone or together with some apparatus in the embodiments of the present disclosure or some apparatus in related technologies.

Regarding the apparatus in the above embodiment, the specific manner in which each module performs operations has been described in detail in the embodiment of the method, and will not be elaborated here.

An embodiment of the present disclosure provides a communication device, including:
a processor; and
a memory for storing processor-executable instructions;
wherein the processor is configured to implement the information processing method of any embodiment of the present disclosure when running the executable instructions.

In one embodiment, the communication device may include but is not limited to at least one of: a base station or a UE.

The processor may include various types of storage media, which are non-temporary computer storage media that can continue to memorize information stored thereon after the user device is off power.

The processor may be connected to the memory via a bus or the like, and may be used to read an executable program stored in the memory, for example, at least one of the methods shown in FIG. 2 to FIG. 6.

An embodiment of the present disclosure also provides a computer storage medium storing a computer executable program, which implements the information processing method of any embodiment of the present disclosure when the executable program is executed by a processor, for example, at least one of the methods shown in FIG. 2 to FIG. 6.

Regarding the apparatus or storage medium in the above embodiments, the specific manner in which each module performs the operation has been described in detail in the embodiment of the method, and will not be elaborated here.

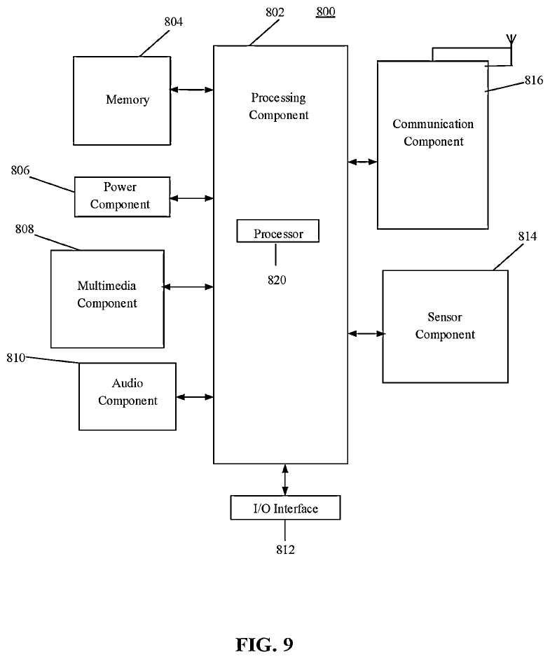

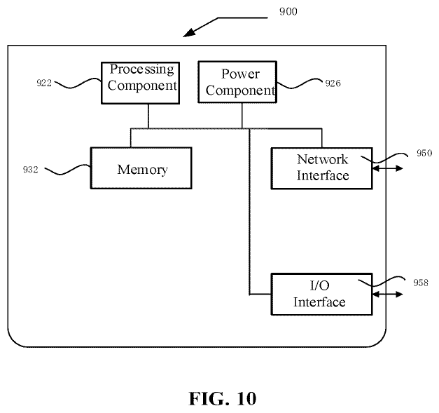

FIG. 9 is a block diagram of a user device 800 according to an exemplary embodiment. For example, the user device 800 may be a mobile phone, a computer, a digital broadcast user device, a messaging device, a game console, a tablet device, a medical device, a fitness device, a personal digital assistant, and the like.

Referring to FIG. 9, the user device 800 may include one or more of the following components: a processing component 802, a memory 804, a power supply component 806, a multimedia component 808, an audio component 810, an input/output (I/O) interface 812, a sensor component 814, and a communication component 816.

The processing component 802 generally controls the overall operations of the user device 800, such as operations associated with display, telephone calls, data communications, camera operations, and recording operations. The processing component 802 may include one or more processors 820 to execute instructions to complete all or part of the steps of the above method. Additionally, processing component 802 may include one or more modules that facilitate interaction between processing component 802 and other components. For example, processing component 802 may include a multimedia module to facilitate interaction between multimedia component 808 and processing component 802.

The memory 804 is configured to store various types of data to support operations at the user device 800. Examples of such data include instructions for any application or method operating on the user device 800, contact data, phonebook data, messages, pictures, videos, etc. The memory 804 can be realized by any type of volatile or non-volatile storage device or their combination, such as static random access memory (SRAM), electrically erasable programmable read only memory (EEPROM), erasable programmable read only memory (EPROM), programmable read only memory (PROM), read only memory (ROM), magnetic memory, flash memory, magnetic disk or optical disk.

The power supply component 806 provides power to various components of the user device 800. The power component 806 may include a power management system, one or more power supplies, and other components associated with generating, managing, and distributing power for user device 800.

The multimedia component 808 includes a screen providing an output interface between the user device 800 and the user. In some embodiments, the screen may include a liquid crystal display (LCD) and a touch panel (TP). If the screen includes a touch panel, the screen may be implemented as a touch screen to receive input signals from a user. The touch panel includes one or more touch sensors to sense touches, swipes, and gestures on the touch panel. The touch sensor may not only sense a boundary of a touch or a swipe action, but also detect duration and pressure associated with the touch or swipe operation. In some embodiments, the multimedia component 808 includes a front camera and/or a rear camera. When the user device 800 is in an operation mode, such as a photographing mode or a video mode, the front camera and/or the rear camera can receive external multimedia data. Each front camera and rear camera can be a fixed optical lens system or have focal length and optical zoom capability.

The audio component 810 is configured to output and/or input audio signals. For example, the audio component 810 includes a microphone (MIC), which is configured to receive an external audio signal when the user device 800 is in an operation mode, such as a call mode, a recording mode and a voice recognition mode. Received audio signals may be further stored in memory 804 or sent via communication component 816. In some embodiments, the audio component 810 also includes a speaker for outputting audio signals.

The I/O interface 812 provides an interface between the processing component 802 and a peripheral interface module, which may be a keyboard, a click wheel, a button, and the like. These buttons may include, but are not limited to: a home button, volume buttons, start button, and lock button.

The sensor component 814 includes one or more sensors for providing terminal 800 with various aspects of status assessment. For example, the sensor component 814 can detect the open/closed state of the device 800, the relative positioning of components, such as the display and the keypad of the user device 800, the sensor component 814 can also detect the user device 800 or a change in the position of a component of the user device 800, the presence or absence of user's contact with the user device 800, the change of orientation or acceleration/deceleration of the user device 800 and the temperature change of the user device 800. The sensor component 814 may include a proximity sensor configured to detect the presence of nearby objects in the absence of any physical contact. The sensor component 814 may also include an optical sensor, such as a CMOS or CCD image sensor, for use in imaging applications. In some embodiments, the sensor component 814 may also include an acceleration sensor, a gyroscope sensor, a magnetic sensor, a pressure sensor or a temperature sensor.

The communication component 816 is configured to facilitate wired or wireless communication between the user device 800 and other devices. The user device 800 can access a wireless network based on communication standards, such as Wi-Fi, 4G or 5G, or a combination thereof. In an exemplary embodiment, the communication component 816 receives broadcast signals or broadcast related information from an external broadcast management system via a broadcast channel. In an exemplary embodiment, the communication component 816 also includes a near field communication (NFC) module to facilitate short-range communication. For example, the NFC module can be implemented based on radio frequency identification (RFID) technology, infrared data association (IrDA) technology, ultra wideband (UWB) technology, bluetooth (BT) technology and other technologies.

In an exemplary embodiment, user device 800 may be implemented by one or more application specific integrated circuits (ASIC), digital signal processors (DSP), digital signal processing devices (DSPD), programmable logic devices (PLD), field programmable gate array (FPGA), controllers, microcontrollers, microprocessors or other electronic components for performing the method described above.

In an exemplary embodiment, there is also provided a non-transitory computer-readable storage medium including instructions, such as the memory 804 including instructions, which can be executed by the processor 820 of the user device 800 to implement the above method. For example, the non-transitory computer readable storage medium may be ROM, random access memory (RAM), CD-ROM, magnetic tape, floppy disk, and optical data storage device, and the like.

As shown in FIG. 10, an embodiment of the present disclosure shows a structure of a base station. For example, the base station 900 may be provided as a network side device. Referring to FIG. 10, the base station 900 includes a processing component 922, which further includes one or more processors, and a memory resource represented by a memory 932 for storing instructions executable by the processing component 922, such as application programs. The application program stored in memory 932 may include one or more modules each corresponding to a set of instructions. In addition, the processing component 922 is configured to execute instructions, so as to perform any of the aforementioned methods applied to the base station.

Base station 900 may also include a power component 926 configured to perform power management of base station 900, a wired or wireless network interface 950 configured to connect base station 900 to a network, and an input-output (I/O) interface 958. The base station 900 can operate based on an operating system stored in the memory 932, such as Windows Server™, Mac OS X™, Unix™, Linux™, FreeBSD™ or the like.

Other embodiments of the invention will be readily apparent to those skilled in the art from consideration of the specification and practice of the invention disclosed herein. This disclosure is intended to cover any modification, use or adaptation of the present invention, these modifications, uses or adaptations follow the general principles of the present invention and include common knowledge or conventional technical means in the technical field not disclosed in this disclosure. The specification and examples are to be considered exemplary only, with a true scope and spirit of the invention being indicated by the following claims.

It should be understood that the present invention is not limited to the precise constructions which have been described above and shown in the accompanying drawings, and various modifications and changes may be made without departing from the scope thereof. The scope of the invention is limited only by the appended claims.

1. An information processing method, executed by a base station, comprising:
sending configuration information of a reference signal,
wherein the configuration information comprises combined configuration information indicating a combined configuration, and
wherein the combined configuration comprises a set of at least one information element (IE) for indicating a resource set of a reference signal.

2. (canceled)

3. The method according to claim 1, wherein one combined configuration is used to configure at least one entity or to configure an entity list,
wherein one entity list comprises at least one of the entity.

4. The method according to claim 1, wherein the configuration information further comprises indication information, and the indication information is used to indicate a single one of the IE that is not configured in the combined configuration.

5. The method according to claim 1, wherein the configuration information further comprises rule information,
wherein the rule information is used to indicate a rule for assigning resource sets of the reference signal to different resource set groups.

6. The method according to claim 5, wherein the rule information comprises a resource set index of part of the resource set and a resource set group index of the corresponding resource set group, and
the rule information is used to indicate that the resource set indicated by the resource set index and at least one previous resource set are assigned to the resource set group indicated by the resource set group index corresponding to the resource set index, or
the rule information is used to indicate that the resource set indicated by the resource set index and at least one subsequent resource set are assigned to the resource set group indicated by the resource set group index corresponding to the resource set index.

7. The method according to claim 5, wherein the rule information comprises a resource set index of part of the resource set and a resource set group index of the corresponding resource set group, and
the rule information is used to indicate that the resource set indicated by the resource set index and the resource set between the resource set indicated by the resource set index and the resource set indicated by the previous resource set index are assigned to the resource set group indicated by the resource set group index corresponding to the resource set index, and/or
the rule information is used to indicate that the resource set indicated by a first resource set index and the resource set before the resource set indicated by the first resource set index are assigned to the resource set group indicated by the resource set group index corresponding to the first resource set index.

8. The method according to claim 5, wherein the rule information comprises a demarcation resource set index, wherein the demarcation resource set index is used to indicate the resource set as a demarcation point, and
the rule information is used to indicate that the resource set indicated by the next demarcation resource set index and the resource set between the resource set indicated by the next demarcation resource set and the resource set indicated by the previous demarcation resource set index are assigned to the same resource set group, and/or
the rule information is used to indicate that the resource set subsequent to the resource set indicated by a last demarcation resource set index is assigned to a same resource set group; and/or the rule information is used to indicate that the resource set indicated by a first resource set index and the resource set before the resource set indicated by the first resource set index are assigned to the same resource set group.

9. The method according to claim 5, wherein the rule information includes a number of the resource set groups, and
the rule information is used to indicate that the resource sets are evenly assigned into different resource set groups, and/or
the rule information is used to indicate that if a number of the resource sets is not divisible by the number of the resource set groups, the resource sets of the remainder part are assigned to any one of the resource set groups.

10. The method according to claim 1, wherein the configuration information does not include a resource set index indicating the resource set of the reference signal, and
the configuration information is also used to indicate that the resource set index of the resource set is numbered in the order in which the resource sets appear in the configuration information.

11. An information processing method, executed by a user equipment UE, comprising:
receiving configuration information of a reference signal,
wherein the configuration information comprises combined configuration information indicating a combined configuration, and
wherein the combined configuration comprises a set of at least one information element (IE) for indicating a resource set of a reference signal.

12. (canceled)

13. The method according to claim 11, wherein one combined configuration is used to configure at least one entity or to configure an entity list and
wherein one entity list comprises at least one of the entity.

14. The method according to claim 11, wherein the configuration information further comprises indication information, and the indication information is used to indicate a single one of the IE that is not configured in the combined configuration.

15. The method according to claim 11, wherein the configuration information further comprises rule information, and
wherein the rule information is used to indicate a rule for assigning resource sets of the reference signal to different resource set groups.

16. The method according to claim 15, wherein the rule information comprises a resource set index of part of the resource set and a resource set group index of the corresponding resource set group, and
the rule information is used to indicate that the resource set indicated by the resource set index and at least one previous resource set are assigned to the resource set group indicated by the resource set group index corresponding to the resource set index, or
the rule information is used to indicate that the resource set indicated by the resource set index and at least one subsequent resource set are assigned to the resource set group indicated by the resource set group index corresponding to the resource set index.

17. The method according to claim 15, wherein the rule information comprises a resource set index of part of the resource set and a resource set group index of the corresponding resource set group, and
the rule information is used to indicate that the resource set indicated by the resource set index and the resource set between the resource set indicated by the resource set index and the resource set indicated by the previous resource set index are assigned to the resource set group indicated by the resource set group index corresponding to the resource set index, and/or
the rule information is used to indicate that the resource set indicated by a first resource set index and the resource set before the resource set indicated by the first resource set index are assigned to the resource set group indicated by the resource set group index corresponding to the first resource set index.

18. The method according to claim 15, wherein the rule information comprises a demarcation resource set index, wherein the demarcation resource set index is used to indicate the resource set as a demarcation point, and
the rule information is used to indicate that the resource set indicated by the next demarcation resource set index and the resource set between the resource set indicated by the next demarcation resource set and the resource set indicated by the previous demarcation resource set index are assigned to the same resource set group, and/or
the rule information is used to indicate that the resource set subsequent to the resource set indicated by a last demarcation resource set index is assigned to a same resource set group; and/or the rule information is used to indicate that the resource set indicated by a first resource set index and the resource set before the resource set indicated by the first resource set index are assigned to the same resource set group.

19. The method according to claim 15, wherein the rule information includes a number of the resource set groups, and
the rule information is used to indicate that the resource sets are evenly assigned into different resource set groups, and/or
the rule information is used to indicate that if a number of the resource sets is not divisible by the number of the resource set groups, the resource sets of the remainder part are assigned to any one of the resource set groups.

20. The method according to claim 11, wherein the configuration information does not include a resource set index indicating the resource set of the reference signal, and
the configuration information is also used to indicate that the resource set index of the resource set is numbered in the order in which the resource sets appear in the configuration information.

21-22. (canceled)

23. A communication device, comprising:
a processor; and
a memory storing instructions executable by the processor,
wherein the processor is configured to implement the information processing method according to claim 1 when executing the instructions.

24. (canceled)

25. A communication device, comprising:
a processor; and
a memory storing instructions executable by the processor,
wherein the processor is configured to implement the information processing method according to claim 11 when executing the instructions.
